(19) United States
(12) Patent Application Publication
(10) Pub. No.: US 2022/0061404 A1
(43) Pub. Date: Mar. 3, 2022

(54) Facemasks Integral with Shirts

(71) Applicant: Charles A. Horwatt, Irwin, PA (US)

(72) Inventor: Charles A. Horwatt, Irwin, PA (US)

(21) Appl. No.: 17/463,118

(22) Filed: Aug. 31, 2021

Related U.S. Application Data
(60) Provisional application No. 63/072,882, filed on Aug. 31, 2020.

(51) Int. Cl. A41B 1/08; A41D 13/11; A62B 23/02

(52) U.S. Cl. CPC A41B 1/08; A62B 23/02; A41D 13/11

(57) ABSTRACT

A turtleneck has a front, upper panel region that includes an integral facemask and an elongated elastic band component for keeping the front, upper panel adjacent the wearer's nose and mouth WITHOUT having any sections that overlap with the same wearer's ears. A first version is upper panel only. A second incorporates a replaceable filter in the front of that same panel, accessible either through the exterior or interior of the upper panel. A third version replaces the filter access with a clear plastic panel or window. A stand-alone alternative incorporates a plurality of flat stiffeners rising up from a cowl neck region of that turtleneck for forming a spaced apart dam/air deflector.

### CROSS-REFERENCE TO RELATED APPLICATIONS

This application is a perfection of pending U.S. Provisional Application Ser. No. 63/072,882, filed on Aug. 31, 2020, the disclosure of which is fully incorporated herein.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable.

### STATEMENT REGARDING PRIOR DISCLOSURES BY THE INVENTOR OR A JOINT INVENTOR

Not Applicable.

### BACKGROUND OF THE INVENTION

### (1) Field of the Invention.

This invention relates to facemasks and improvements for making them more comfortable to wear. Particularly, it relates to masks that can be made integral with the top of a shirt, especially one having a turtleneck top. These improvements are especially aimed at customers who might otherwise feel confined, or claustrophobic, with other known mask products. Yet another variation herein incorporates a clear, lip reading window into the turtleneck-incorporated facemask line of apparel: sleeveless, short sleeve and long sleeve variations of shirts for men, women and children/teens.

With the virus pandemic of 2020, most individuals are now being required in many jurisdictions to wear facemasks when in public (especially when social distancing is either impossible or impractical). When wearing masks in a store, restaurant or other public setting, such masks tend to go on and off . . . repeatedly. They are uncomfortable to wear, or leave ON (i.e., over one's mouth and nose) for long stretches of time. Most disheartening are the various mask types that wrap around the wearer's ears. These models of mask alternatives are all EAR-FREE™. They may be made and sold under the SHIRZS™ mark/logo.

### (2) Description of Related Art including information disclosed under 37 CFR 1.97 and 1.98

The Corona virus (or Covid) pandemic of 2020 has made facemask-wearing more common if not mandatory in many (if not all) social settings, including the standard workplace for most jurisdictions. There are numerous mask designs made and sold on the internet . . . and other models of homemade masks marketed on various street corners. On Etsy, various models of turtleneck masks are shown for sale but all of them require pulling up and lapping about the shirt wearer's ears. YouTube even included a How To link for retrofitting one's existing turtleneck shirts for similar ear-wrapping connections.

But nothing seen to date show the alternatives depicted hereinbelow, namely: an elastically held, lower face wraparound integral to the top of a turtleneck whether sleeveless, short sleeved or long sleeved. A first variation thereof includes a hidden, preferably front access, slot into which one may insert a replaceable filter.

A second, stand-alone model has a plurality of built in spacers for keeping the front “dam” of a face mask/protector a set distance “d” in front of the shirt wearer's nose and mouth. A third model incorporates a front clear panel over the mouth and lips covering area in an integrally masked turtleneck shirt, top or hoodie.

Lastly, there is a more elaborate version that includes a clear panel/shield for slipping into an integral shield holder component in the upper front of a shirt. The latter is intended to provide virus protection from the neck UP, rather than from a forehead connected neck down approach. Ideally, the latter masks should wrap around the wearer's neck for providing at least 90 degree protection though neck rotatability may extend such coverage to just slightly less than 180 degrees in still other variations.

### BRIEF SUMMARY OF THE INVENTION

Preferred embodiments of this invention are meant to made integral with the mask wearer's shirt—mostly emanating from the cowl of a turtleneck or uppermost t-shirt collar. The various models are meant to be less restrictive by NOT looping over the backs of the wearer's ears. In most cases, one or more of these integral shirt “mask” models are less confining/claustrophobic about the wearer's nose and mouth. In two instances, these mask alternatives assist with the wearer's mouth being more visible by using a transparent insert panel, permanent or periodically replaceable, near (i.e., adjacent) the mouth region of the wearer's turtleneck collar extension in the LIP READERS™ edition OR by providing removable, replaceable clear upward panels for snapping into an upward shield holder of the SHIELDS UP™ model.

One preferred model comprises a turtleneck having a front, upper panel region that includes an integral facemask and an elongated elastic band component for keeping the front, upper panel adjacent the wearer's nose and mouth WITHOUT having any sections that overlap with the same wearer's ears. A first version is upper panel only. A second incorporates a replaceable filter in the front of that same panel, accessible either through the exterior or interior of the upper panel. A third version replaces the filter access with a clear plastic panel or window. A stand-alone alternative incorporates a plurality of flat stiffeners rising up from a cowl neck region of that turtleneck for forming a spaced apart dam/air deflector.

### BRIEF DESCRIPTION OF THE SEVERAL VIEWS OF THE DRAWING(S)

Further features, objectives and advantages of this invention will be clearer from the following detailed description made with reference to the accompanying drawings in which:

FIG. 1A is a front plan view showing one embodiment of integral shirt facemask that includes a tight elastic ring for wearing over the nose and mouth when the integral facemask is pulled up from around the shirt wearer's neck when needed;

FIG. 1B is a front plan view showing one variation of the shirt facemask from FIG. 1A that further includes a slot for receiving a replaceable filter component;

FIG. 2 is a rear plan view showing the elastically held mask from FIG. 1A worn rather tightly about the shirt wearer's lower rear head/upper neck, but well away from the wearer's ears;

FIG. 3 is a side view of the first integral mask concept from FIGS. 1A and 2. Note how the wearer's nose and mouth are shown in dotted lines beneath the front of this mask arrangement;

FIG. 4 is a front plan view showing a first alternate embodiment of integral shirt facemask that includes a plurality of mask stiffeners for causing a cowl of this shirt wearer's mask region to cover his nose and mouth (shown in dotted lines);

FIG. 5 is a side view of the raised “dam” mask version from FIG. 4 meant to keep the wall of this mask a set distance ‘d’ away from the wearer's nose and mouth;

FIG. 6 is a side view of another “dam mask” alternative in which the wall stiffening components are meant to partially angle (or curve) slightly inward from the top of this mask wearer's integral shirt extension component;

FIG. 7 is a front plan view showing a third embodiment of integral shirt facemask that includes a mouth or lip window region as part of its turtleneck cowl extension;

FIG. 8 is a front plan view showing a fourth embodiment of shirt facemask that includes an upwardly extending shield component that repeatedly snaps into a shield-holder extension that wraps at least 90 degrees about the uppermost shirt collar of the wearer; and

FIG. 9 is a side cross-sectional view of the shield holder and up-shield from FIG. 8, for raising a protective covering directly in front of the shirt wearer's nose and mouth.

### DETAILED DESCRIPTION OF THE INVENTION

In the accompanying FIGS., common components to the respective embodiments are commonly numbered, though in the next Hundred series.

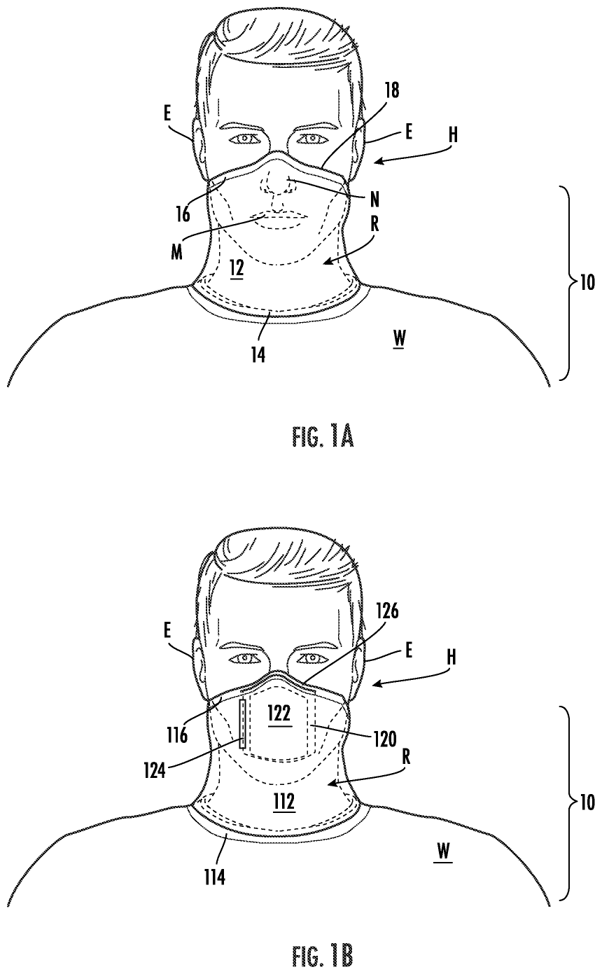

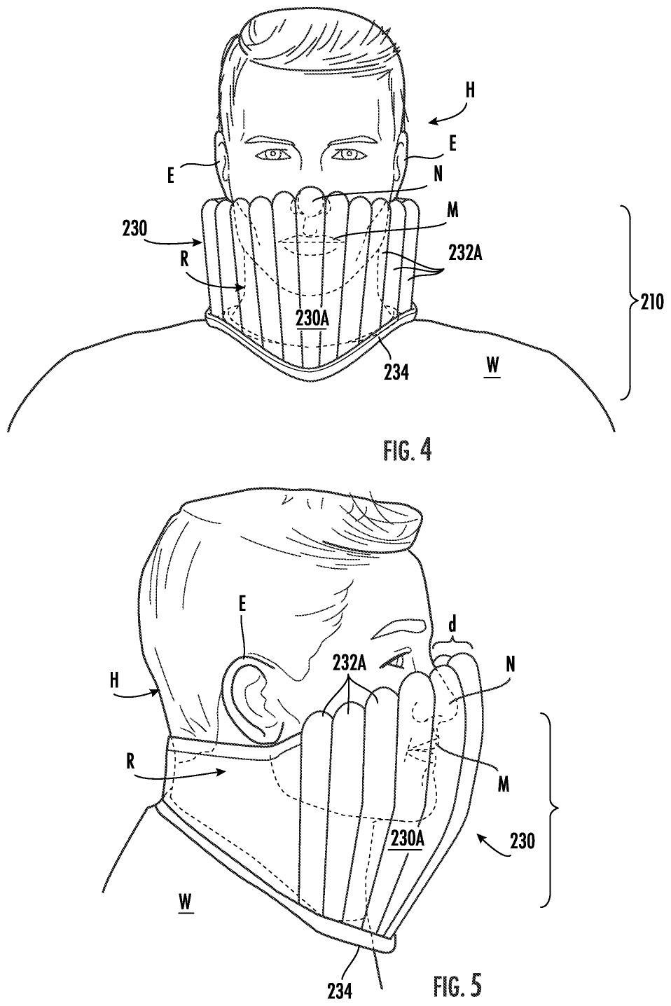

As shown in the accompanying FIGS., the essence of this invention is meant to provide facemask wearers with an integral extension to the cowl of a turtleneck shirt regardless of whether that shirt is sleeveless, short sleeved or long sleeved. The shirts themselves can be made from knit, fleece, nylon, cotton, flannel or most any other existing shirt material. But they all will have an ability to fully incorporate therein a facemask component. For the first of the four main variations disclosed herein, the mask is fastened tightly about the shirt wearer's nose and mouth while keeping away from about the backs of the wearer's ears. Preferred versions accomplish this using a continuous band of elastic about the whole upper neck region of the shirt neck, or cowl. This variation of mask attachment replaces the often-irritating ear loops of many facemasks—including those that have incorporated ear-holding masks into shirts and sweaters. FIGS. 1A through 3 show this elastically held mask from various angles.

More particularly, in FIGS. 1A, 2 and 3, there is shown a turtleneck 10 for extending up and over a neck region R of the wearer W without requiring any contact, wraparound or otherwise, with the wearer's ears E. Turtleneck 10 includes a front upper panel region 12 fixedly connected to an uppermost collar region 14 and then designed for pulling up over the nose N and mouth M of wearer W. On an uppermost edge 16 of upper panel region 12, extending fully about the general circumference of the wearer's head H is an elongated elastic strap or band 18 designed for holding the uppermost edge 16 firmly (yet still comfortably) adjacent the bridge of the wearer's nose N . . . but NOT over any portion of the back of the wearer's ears E.

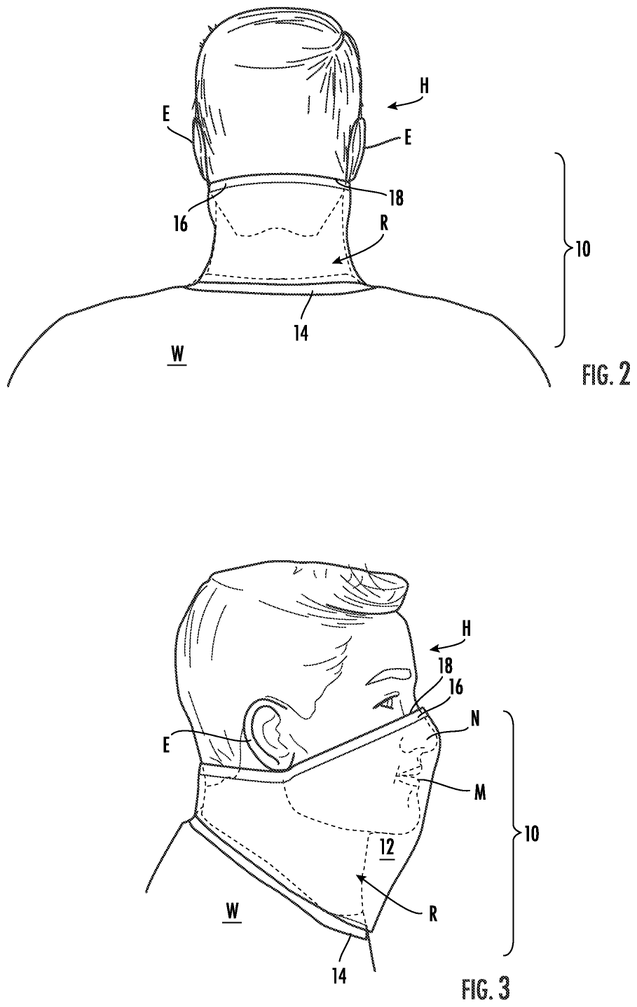

FIG. 1B is a first variation of the present invention. It includes a turtleneck 110 having a front upper panel region 112 with its own elastic band 118 in the uppermost edge 116 of upper panel region 112. But, unlike the straight “mask only” versions of FIGS. 1A, 2 and-3, this first preferred alternative includes a panel pocket 120 for housing a replaceable air filter cartridge insert 122, possibly one that is cloth or fibrous. More preferably, cartridge insert 122 is a respirator-style, washable and reusable face filter element.

In FIG. 1B, access to the panel 120 is made from the turtleneck's exterior through slot 124. There is also included a stiffener component 126 for squeezing firmly onto the upper bridge of the wearer's nose N. It may be made from metal or a semi-moldable polymer/plastic. Though not shown, yet another alternative would allow for access through its own slot on the interior of the front upper panel region of turtleneck 110.

FIGS. 4 through 6 show a third alternative of turtleneck 210 with a front dam mask 230 in one of two varieties. The first dam mask 230A consists of a plurality of front flat stiffeners 232A that not only raise the cowl area 234 of turtleneck 210 up and over the nose

N and mouth M of wearer W, but also a set distance (element “d”) away from the same nose and mouth area. This is meant to assist with the claustrophobic nature of many facemasks. Stiffeners 232A will raise shirt material UP but yet a fixed distance (preferably about 1.5 to 3 inches) out and away from his/her nose and mouth.

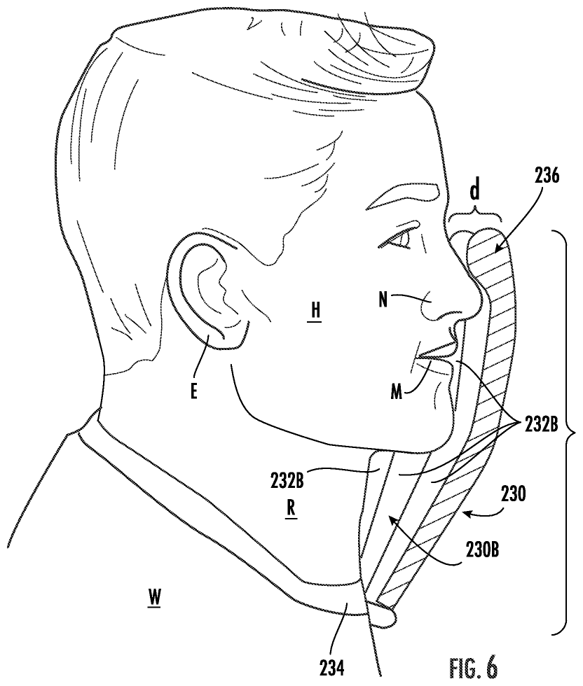

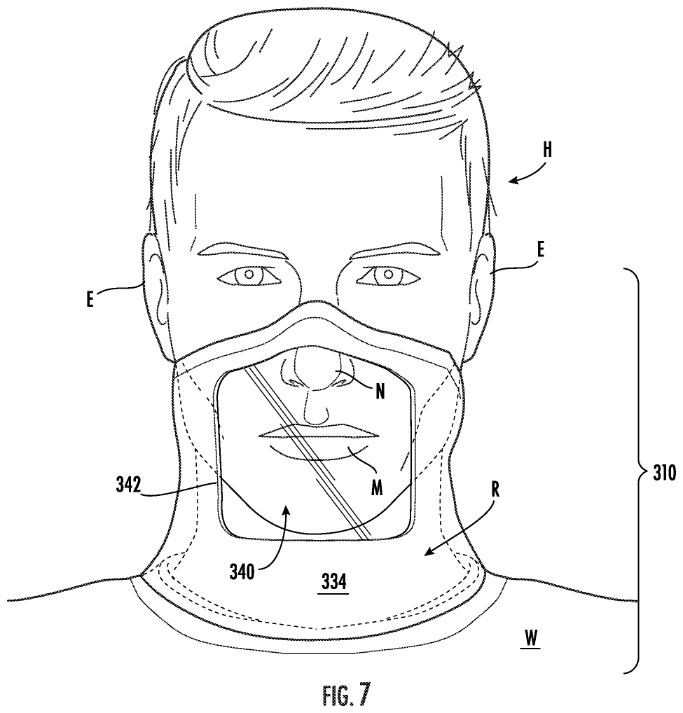

In first dam mask version 230A, FIGS. 4 and 5, stiffeners 232A are a plurality of straight plastic inserts that give the turtleneck front somewhat of a picket-fence appeal. In the next, slight variation, 230B, the subject of FIG. 6, the tops 236 to its plastic insert stiffeners 232B are purposefully/intentionally angled (or at least partially curved) inward for giving the spaced face shield to this turtleneck alternative somewhat of a baseball fielder's glove appearance.

In the next alternative of turtleneck 310, as shown in FIG. 7, there is a clear window 340 incorporated into the cowl area 334, window 340 serving as a means for enabling others to better lip read the wearer's spoken words. There can be numerous clear polymers incorporated in a neck surround border 342 for holding window 340. Preferred measurements for window 340 are about 1.5 to 3 inches tall and about 2 or 2.5 to 5 inches wide. The goal is to permanently incorporate such a clear window into the cowl area 334 of turtleneck 310 while still enabling regular laundering of the same (without window 340 becoming dislodged, disconnected OR clouded/discolored).

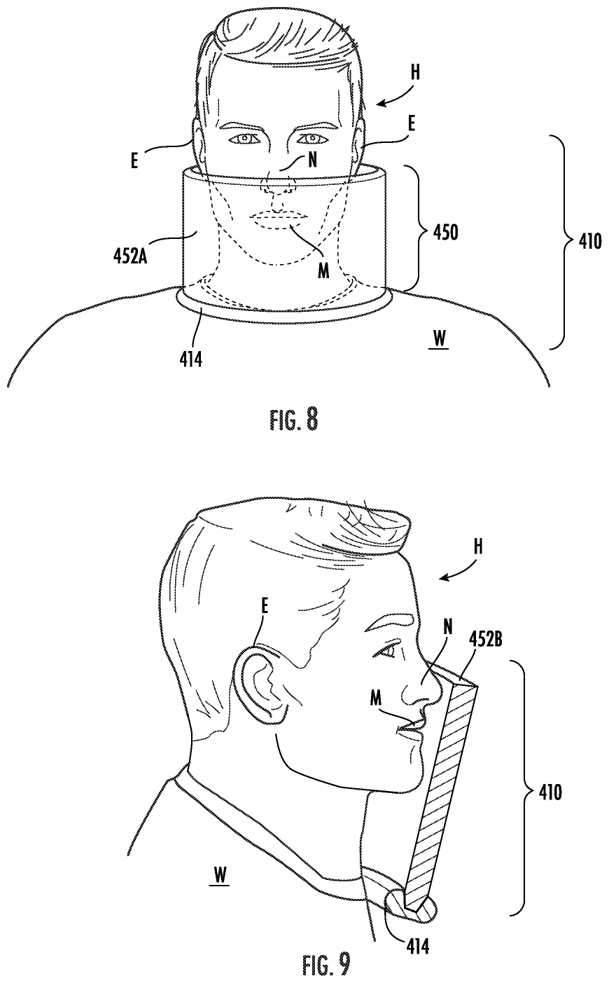

FIGS. 8 and 9 address a fourth variation of mask-incorporated turtleneck 410 per this invention. The mask component 450 for this version serves as a thin, clear “upshield” from the neck region R rather than a wearer forehead down type. Depending on the thickness of mask component 450, its mask holding, neck wraparound 452A may enable repeated, snap-in inserting and removals (for cleaning). Mask component 450 SHOULD encircle a good portion of the wearer's neck region R in an awkward, dog collar-like equivalent. Preferably, mask component 450 covers at least about 90 degrees of neck rotation about the upper collar area 414 to turtleneck 410. In a first slight variation, the curved neck wraparound 452B, preferably a thin plexi mask holder, could wrap about 120-135 degrees about the head of wearer W. In still other variations (not shown), outer side-edges of this mask component may slope downward, towards the wearer's shoulders.

Numerous plastic materials may be used to make shields for mask component 450—either for repeated reuse, OR for only a few uses before full replacement. The shield holders, or neck wraparounds (452A or 452B) can be a curved, double lip into which the mask component shield would snap in for holding.

Although the foregoing description of the invention has shown, described and pointed out novel features of the invention, it will be understood that various omissions, substitutions, and changes in the form of the detail of the apparatus as illustrated, as well as the uses thereof, may be made by those skilled in the art without departing from the spirit of the present invention. Consequently, the scope of the invention should not be limited to the foregoing discussion but should be defined by the appended claims.

### Sequence Listing

Not applicable.

What is claimed is:

1. A turtleneck having incorporated into a front, upper panel a region capable of serving as an integral facemask, said front, upper panel including an elongated elastic band component for keeping the front, upper panel adjacent a wearer's nose and mouth when pulled up over the wearer's nose and mouth, without requiring any portion of the turtleneck wrapping over and about the wearer's ears.

2. The turtleneck of claim 1 wherein the elongated elastic band component extends completely about an uppermost perimeter of the front, upper panel.

3. The turtleneck of claim 1, which is sleeveless, short sleeved or long sleeved.

4. The turtleneck of claim 1 wherein the front, upper panel includes at least one slot into which a removable filter may be inserted in a filter pocket in the front, upper panel adjacent the wearer's nose and mouth.

5. The turtleneck of claim 4 wherein the at least one slot is accessible from an exterior of the front, upper panel.

6. The turtleneck of claim 4 wherein the at least one slot is accessible from inside the front, upper panel.

7. The turtleneck of claim 1 wherein the front, upper panel includes at least one slot into which a clear window panel may be inserted adjacent the wearer's nose and mouth.

8. The turtleneck of claim 7 wherein the clear window panel is temporarily inserted in a pass-through panel pocket adjacent the wearer's nose and mouth.

9. The turtleneck of claim 7 wherein the clear window panel is permanently inserted in a pass-through panel pocket adjacent the wearer's nose and mouth.

10. The turtleneck of claim 7 wherein the clear window panel is at least 2 inches tall and at least 3 inches wide.

11. A turtleneck having incorporated into a front, upper panel a region capable of serving as an integral facemask, said front, upper panel including:
(a) an elongated elastic band component for keeping the front, upper panel adjacent a wearer's nose and mouth when pulled up over the wearer's nose and mouth, without requiring any portion of the turtleneck wrapping over and about the wearer's ears; and
(b) at least one slot into which a removable filter may be inserted in a filter pocket in the front, upper panel adjacent the wearer's nose and mouth.

12. The turtleneck of claim 11 wherein the at least one slot is accessible from an exterior of the front, upper panel.

13. The turtleneck of claim 11 wherein the at least one slot is accessible from inside the front, upper panel

14. A turtleneck having incorporated into a front, upper panel a breath deflecting cowl wall consisting of a plurality of vertically extending panel stiffeners adapted for keeping the cowl wall a set distance from a wearer's nose and mouth.

15. The turtleneck of claim 14 wherein each of the plurality of stiffeners is substantially planar.

16. The turtleneck of claim 14 wherein each of the plurality of stiffeners terminates in an inwardly curved upper tip.

17. The turtleneck of claim 14 wherein each of the plurality of stiffeners terminates in an inwardly angled upper tip.

18. The turtleneck of claim 14 wherein the set distance is at least 1.5 inches.

19. The turtleneck of claim 14 wherein the set distance is less than about 3 inches.
